(19) United States
(12) Patent Application Publication
(10) Pub. No.: US 2026/0238944 A1
(43) Pub. Date: Aug. 13, 2026

(54) DYNAMIC ARTIFICIAL AUDIO FOR LARGE-SCALE SPATIAL VOICE MIXING

(71) Applicant: Roblox Corporation, San Mateo, CA (US)

(72) Inventors: Josh ANON, Los Angeles, CA (US); Tian LIM, San Mateo, CA (US); Behnam BASTANI, San Mateo, CA (US); John STAUFFER, San Mateo, CA (US); Layla MAH, San Mateo, CA (US)

(73) Assignee: Roblox Corporation, San Mateo, CA (US)

(21) Appl. No.: 19/052,689

(22) Filed: Feb. 13, 2025

(51) Int. Cl. H04S 5/00

(52) U.S. Cl. CPC H04S 5/00

(57) ABSTRACT

A method includes detecting audio sources that are audible to a first avatar in a virtual experience. The method further includes generating audio streams for a predetermined number of the audio sources that are audible in the virtual experience. The method further includes identifying one or more respective parameters associated with remaining audio sources that are audible in the virtual experience. The method further includes replacing one or more of the remaining audio sources that are audible with artificial audio based on the one or more respective parameters. The method further includes mixing the audio streams with the artificial audio. The method further includes providing the mixed audio to one or more speakers for output on a client device associated with the first avatar.

### FIELD

Embodiments relate generally to generating spatial audio for a virtual environment. More particularly, embodiments relate to methods, systems, and computer-readable media that reduce the computational expense of generating audio by replacing a subset of audio sources with artificial audio based on different parameters.

### BACKGROUND

Audio streams in a virtual environment are designed to simulate audio in the real world where sounds are emitted from a user's avatar wherever the avatar is in three-dimensional (3D) space. As additional users join the virtual environment, more spatial audio is added to an audio mix and the combination of audio streams is more computationally expensive to transmit from a server to each client device.

One solution for reducing the computational expense of generating an audio mix restricts the audio mixing to N-most audible users. However, this may result in audio mixes that are less realistic, such as audio mixes created to provide simulated audio to a user that is attending a packed virtual stadium.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method includes detecting audio sources that are audible to a first avatar in a virtual experience. The method further includes generating audio streams for a predetermined number of the audio sources that are audible in the virtual experience. The method further includes identifying one or more respective parameters associated with remaining audio sources that are audible in the virtual experience. The method further includes replacing one or more of the remaining audio sources that are audible with artificial audio based on the one or more respective parameters. The method further includes mixing the audio streams with the artificial audio. The method further includes providing the mixed audio to one or more speakers for output on a client device associated with the first avatar.

In some embodiments, the method further includes determining a position of the first avatar in the virtual experience and determining the predetermined number of audio sources that are audible in the virtual experience based on one or more of a distance between first avatar and respective positions of the predetermined audio sources, respective amplitudes of sound waves associated with the predetermined audio sources, and combinations thereof. In some embodiments, the method further includes determining a position of the first avatar in the virtual experience and generating a plurality of clusters of the remaining audio sources that are audible based on respective positions of the remaining audio sources that are audible, wherein replacing the remaining audio sources that are audible with the artificial audio based on the one or more respective parameters includes replacing the remaining audio sources that are audible with respective artificial audio for individual clusters of the plurality of clusters. In some embodiments, generating the plurality of clusters of the remaining audio sources that are audible includes partitioning the virtual experience into an octree by recursively subdividing the virtual experience into one or more progressively smaller sets of octants and associating each octant within the octree with a corresponding cluster from the plurality of clusters. In some embodiments, the respective artificial audio for individual clusters of the plurality of clusters is generated by, for the cluster: identifying amplitudes and frequencies of the remaining audio sources that are audible in the cluster and generating the artificial audio for the cluster by modifying the remaining audio sources that are audible based on the amplitudes and the frequencies.

In some embodiments, the method further includes sampling streams of live audio in individual clusters of the plurality of clusters and averaging the sampled streams of live audio, where mixing the audio streams with the artificial audio includes mixing, for individual clusters, the averaged streams of live audio, the artificial audio, and the audio streams. In some embodiments, the one or more respective parameters are selected from a group of an orientation associated with each of the remaining audio sources that are audible in individual clusters of the plurality of clusters, a density of the remaining audio sources that are audible in individual clusters of the plurality of clusters, a number of other avatars that are speaking in individual clusters of the plurality of clusters, a decibel level of the remaining audio sources that are audible in individual clusters of the plurality of clusters, an average frequency of the remaining audio sources that are audible in individual clusters of the plurality of clusters, and combinations thereof and the streams of live audio are sampled based on the one or more respective parameters. In some embodiments, the method further includes transmitting information about the one or more respective parameters associated with the remaining audio sources that are audible and the audio streams to the client device, where mixing the audio streams with the artificial audio is performed locally at the client device.

According to one aspect, non-transitory computer-readable medium with instructions that, when executed by one or more processors at a client device, cause the one or more processors to perform operations. The operations include: detecting audio sources that are audible to a first avatar in a virtual experience; generating audio streams for a predetermined number of the audio sources that are audible in the virtual experience; identifying one or more respective parameters associated with remaining audio sources that are audible in the virtual experience; replacing one or more of the remaining audio sources that are audible with artificial audio based on the one or more respective parameters; mixing the audio streams with the artificial audio; and providing the mixed audio to one or more speakers for output on a client device associated with the first avatar.

In some embodiments, the operations further include determining a position of the first avatar in the virtual experience and determining the predetermined number of audio sources that are audible in the virtual experience based on one or more of a distance between first avatar and respective positions of the predetermined audio sources, respective amplitudes of sound waves associated with the predetermined audio sources, and combinations thereof. In some embodiments, the operations further include determining a position of the first avatar in the virtual experience and generating a plurality of clusters of the remaining audio sources that are audible based on respective positions of the remaining audio sources that are audible, wherein replacing the remaining audio sources that are audible with the artificial audio based on the one or more respective parameters includes replacing the remaining audio sources that are audible with respective artificial audio for individual clusters of the plurality of clusters. In some embodiments, generating the plurality of clusters of the remaining audio sources that are audible includes partitioning the virtual experience into an octree by recursively subdividing the virtual experience into one or more progressively smaller sets of octants and associating each octant within the octree with a corresponding cluster from the plurality of clusters. In some embodiments, the respective artificial audio for individual clusters of the plurality of clusters is generated by, for the cluster: identifying amplitudes and frequencies of the remaining audio sources that are audible in the cluster and generating the artificial audio for the cluster by modifying the remaining audio sources that are audible based on the amplitudes and the frequencies. In some embodiments, the operations further include sampling streams of live audio in individual clusters of the plurality of clusters and averaging the sampled streams of live audio, where mixing the audio streams with the artificial audio includes mixing, for individual clusters, the averaged streams of live audio, the artificial audio, and the audio streams.

According to one aspect, a system includes one or more processors and a memory coupled to the processor, with instructions stored thereon that, when executed by the one or more processors, cause the one or more processors to perform operations. The operations include: detecting audio sources that are audible to a first avatar in a virtual experience; generating audio streams for a predetermined number of the audio sources that are audible in the virtual experience; identifying one or more respective parameters associated with remaining audio sources that are audible in the virtual experience; replacing one or more of the remaining audio sources that are audible with artificial audio based on the one or more respective parameters; mixing the audio streams with the artificial audio; and providing the mixed audio to one or more speakers for output on a client device associated with the first avatar.

In some embodiments, the operations further include determining a position of the first avatar in the virtual experience and determining the predetermined number of audio sources in the virtual experience that are audible to the first avatar based on one or more of a distance between first avatar and respective positions of the predetermined audio sources, respective amplitudes of sound waves associated with the predetermined audio sources, and combinations thereof. In some embodiments, the operations further include determining a position of the first avatar in the virtual experience and generating a plurality of clusters of the remaining audio sources that are audible based on respective positions of the remaining audio sources that are audible, wherein replacing the remaining audio sources that are audible with the artificial audio based on the one or more respective parameters includes replacing the remaining audio sources that are audible with respective artificial audio for individual clusters of the plurality of clusters. In some embodiments, generating the plurality of clusters of the remaining audio sources that are audible includes partitioning the virtual experience into an octree by recursively subdividing the virtual experience into one or more progressively smaller sets of octants and associating each octant within the octree with a corresponding cluster from the plurality of clusters. In some embodiments, the respective artificial audio for individual clusters of the plurality of clusters is generated by, for the cluster: identifying amplitudes and frequencies of the remaining audio sources that are audible in the cluster and generating the artificial audio for the cluster by modifying the remaining audio sources that are audible based on the amplitudes and the frequencies. In some embodiments, the operations further include sampling streams of live audio in individual clusters of the plurality of clusters and averaging the sampled streams of live audio, where mixing the audio streams with the artificial audio includes mixing, for individual clusters, the averaged streams of live audio, the artificial audio, and the audio streams.

### BRIEF DESCRIPTION OF THE DRAWINGS

FIG. 1 is a block diagram of an example network environment, according to some embodiments described herein.

FIG. 2 is a block diagram of an example computing device, according to some embodiments described herein.

FIG. 3 is an example illustration of sound localization relative to a listener, according to some embodiments described herein.

FIG. 4 is an example illustration of how sound attenuation works as a function of distance, according to some embodiments described herein.

FIG. 5 is an example illustration of using a threshold distance from a first avatar to audio sources to determine whether to replace the audio sources with artificial audio, according to some embodiments described herein.

FIG. 6 is an example illustration of a virtual experience that illustrates three sets of octants in an octree, according to some embodiments described herein.

FIG. 7 is an example illustration of two audio source samples that are averaged, according to some embodiments described herein.

FIG. 8 is an example illustration of different ways to sample clusters to replace the audio sources with artificial audio, according to some embodiments described herein.

FIG. 9 is a block diagram of an example process for mixing artificial audio with additional audio that is output to a left speaker and a right speaker, according to some embodiments described herein.

FIG. 10 is a flow diagram of an example method to replace a plurality of audio sources with artificial audio based on one or more respective parameters that are mixed on a client device, according to some embodiments described herein.

FIG. 11 is a flow diagram of another example method to replace a plurality of audio sources with artificial audio based on one or more respective parameters, according to some embodiments described herein.

### DETAILED DESCRIPTION

### Overview

People can distinguish between a certain number of distinct audio sources (e.g., four to seven audio sources). Virtual experiences may include avatars that generate more audio sources than a user can identify. Generating an audio stream for each audio source has a computational cost for both a virtual experiences server and client devices. If every audio stream in a virtual experience was provided to a user, the computational demands may be prohibitive, for example, they may exceed the ability to provide all the audio streams to a user without introducing user-noticeable delay.

One way to reduce the number of audio streams is to exclude more than a predetermined number of audio sources or to exclude all audio sources that are more than a threshold distance from an avatar in the virtual experience. However, this type of exclusion reduces the realism of a virtual experience.

The disclosure describes an audio application that detects audio sources that are audible to a first avatar in a virtual experience and generates audio streams for a predetermined number of the audio sources that are audible in the virtual experience. For example, the predetermined number may be 3, 4, 5, etc. Audibility may be determined based on distance, amplitude of sound waves associated with the audio sources, and/or other factors. For example, the audio application may determine the four closest audio sources, the four loudest audio sources, a second avatar that is further away from the first avatar but is yelling, a second avatar that is far away from the first avatar but both avatars are using walkie-talkies, etc.

The audio application replaces one or more of the remaining audio sources that are audible with artificial audio. The artificial audio includes an unintelligible mix of sound and/or random pseudo-speech, such as Walla, which is a sound effect imitating the murmur of a crowd in the background. The audio application mixes the audio streams with the artificial audio and provides the mixed audio to one or more speakers for output on a client device.

In some embodiments, the audio application generates clusters of remaining audio sources that are audible. For example, the audio application may partition a virtual experience into an octree and associate each octant in the octree with a corresponding cluster. The audio application may partition the virtual experience based on a first avatar's position such that the first avatar is in a smallest of the octants and the size of the octants (and corresponding clusters) increases as a distance from the first avatar increases. As a result, the process of generating audio is less computationally expensive because the audio sources in each cluster may be combined instead of individually processing each audio source.

Creating separate artificial audio for individual cluster may be computationally expensive. In some embodiments, the artificial audio is a file that is used for individual clusters, but with different modifications based on respective parameters associated with individual clusters. For example, individual clusters may have different amplitudes and frequencies and, as a result, the artificial audio may be modified for respective clusters based on the amplitude and frequency. In some embodiments, the artificial audio file is stored on client devices to reduce the amount of data that is transmitted from a server to the client devices. In some embodiments, the mixing of artificial audio from the artificial audio file with audio streams is performed on the client device and is modified based on the processing capacity and audio playback capabilities of respective client devices.

In some embodiments, the audio application samples streams of live audio from the clusters, averages the sampled streams to avoid identification of expletives in audio, and mixes the live audio with the artificial audio to improve the realism of the mixed audio. As a result, virtual experiences that include crowds are more realistic. For example, if different parts of a crowd in a stadium are chanting, sampling live audio to mix with the artificial audio for different clusters results in the feeling of a crowd with dynamic movement of the chants. In some embodiments, the audio application may be stored on different devices that perform different steps. For example, a first client device may sample streams of live audio and a server and/or a second client device mix the live audio with the artificial audio.

### Network Environment

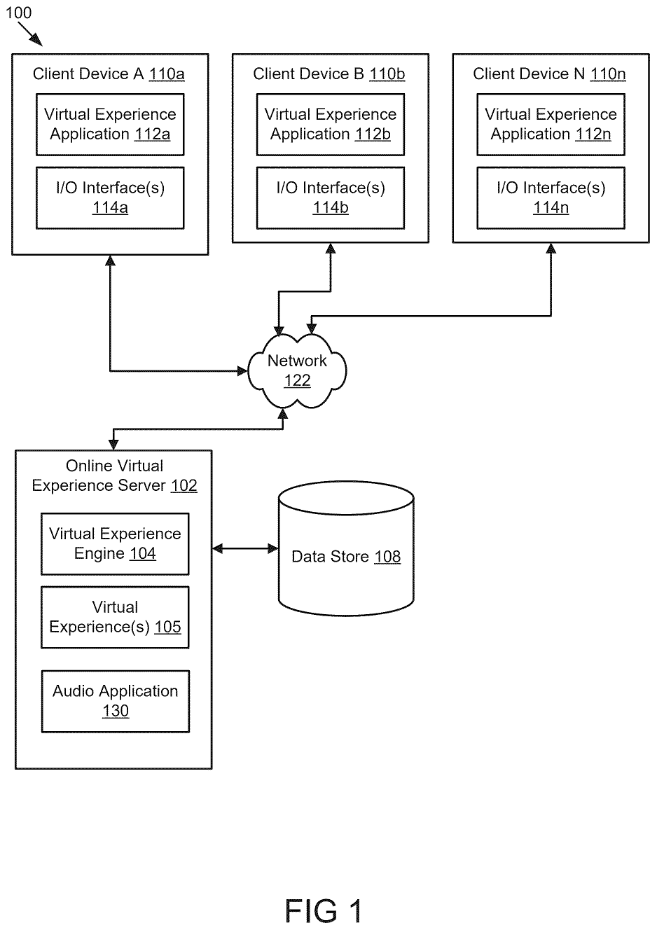

FIG. 1 illustrates an example network environment 100, in accordance with some implementations of the disclosure. FIG. 1 and the other figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The network environment 100 (also referred to as a “platform” herein) includes an online virtual experience server 102, a data store 108, and a client device 110 (or multiple client devices), all connected via a network 122.

The online virtual experience server 102 can include, among other things, a virtual experience engine 104, one or more virtual experiences 105, and an audio application 130. The online virtual experience server 102 may be configured to provide virtual experiences 105 to one or more client devices 110, and to provide audio streams via the audio application 130, in some implementations.

Data store 108 is shown coupled to online virtual experience server 102 but in some implementations, can also be provided as part of the online virtual experience server 102. The data store may, in some implementations, be configured to store advertising data, user data, engagement data, and/or other contextual data in association with the audio application 130.

The client devices 110 (e.g., 110a, 110b, 110n) can include a virtual experience application 112 (e.g., 112a, 112b, 112n), and an I/O interface 114 (e.g., 114a, 114b, 114n) to interact with the online virtual experience server 102, and to view, for example, graphical user interfaces (GUI) through a computer monitor or display (not illustrated). In some implementations, the client devices 110 may be configured to execute and display virtual experiences, which may include virtual user engagement portals as described herein.

Network environment 100 is provided for illustration. In some implementations, the network environment 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In some implementations, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, virtual server, etc.). In some implementations, a server may be included in the online virtual experience server 102, be an independent system, or be part of another system or platform. In some implementations, the online virtual experience server 102 may be a single server, or any combination a plurality of servers, load balancers, network devices, and other components. The online virtual experience server 102 may also be implemented on physical servers, but may utilize virtualization technology, in some implementations. Other variations of the online virtual experience server 102 are also applicable.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user (e.g., user via client device 110) with access to online virtual experience server 102.

The online virtual experience server 102 may also include a website (e.g., one or more web pages) or application back-end software that may be used to provide a user with access to content provided by online virtual experience server 102. For example, users (or developers) may access online virtual experience server 102 using the virtual experience application 112 on client device 110, respectively.

In some implementations, online virtual experience server 102 may include digital asset and digital virtual experience generation provisions. For example, the platform may provide administrator interfaces allowing the design, modification, unique tailoring for individuals, and other modification functions. In some implementations, virtual experiences may include two-dimensional (2D) games, three-dimensional (3D) games, virtual reality (VR) games, or augmented reality (AR) games, for example. In some implementations, virtual experience creators and/or developers may search for virtual experiences, combine portions of virtual experiences, tailor virtual experiences for particular activities (e.g., group virtual experiences), and other features provided through the virtual experience server 102.

In some implementations, online virtual experience server 102 or client device 110 may include the virtual experience engine 104 or virtual experience application 112. In some implementations, virtual experience engine 104 may be used for the development or execution of virtual experiences 105. For example, virtual experience engine 104 may include a rendering engine (“renderer”) for 2D, 3D, VR, or AR graphics, a physics engine, a collision detection engine (and collision response), sound engine, scripting functionality, haptics engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.).

The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110 (not illustrated). In some implementations, each virtual experience 105 may have a different ratio between the virtual experience engine functions that are performed on the online virtual experience server 102 and the virtual experience engine functions that are performed on the client device 110.

In some implementations, virtual experience instructions may refer to instructions that allow a client device 110 to render gameplay, graphics, and other features of a virtual experience. The instructions may include one or more of user input (e.g., physical object positioning), character position and velocity information, or commands (e.g., physics commands, rendering commands, collision commands, etc.).

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “client device 110.” In some implementations, one or more client devices 110 may connect to the online virtual experience server 102 at any given moment. It may be noted that the number of client devices 110 is provided as illustration, rather than limitation. In some implementations, any number of client devices 110 may be used.

In some implementations, each client device 110 may include an instance of the virtual experience application 112. The virtual experience application 112 may be rendered for interaction at the client device 110. During user interaction within a virtual experience or another GUI of the online platform 100, a user may create a first avatar that includes different body parts from different libraries.

The audio application 130 stored on the online virtual experiences server 102 may detect audio sources that are audible to a first avatar in a virtual experience. The audio application 130 generates audio streams for a predetermined number of the audio sources that are audible in the virtual experience. The audio application 130 identifies one or more respective parameters associated with remaining audio sources that are audible in the virtual experience. The audio application 130 replaces one or more of the remaining audio sources that are audible with artificial audio based on the one or more respective parameters.

In some embodiments, the audio application 130 on the online virtual experiences server 102 mixes the audio streams with the artificial audio. In some embodiments, a virtual experience application 112 on a client device 110 mixes the additional audio with the artificial audio. The mixed audio is provided to one or more speakers for output on the client device 110.

### Computing Device

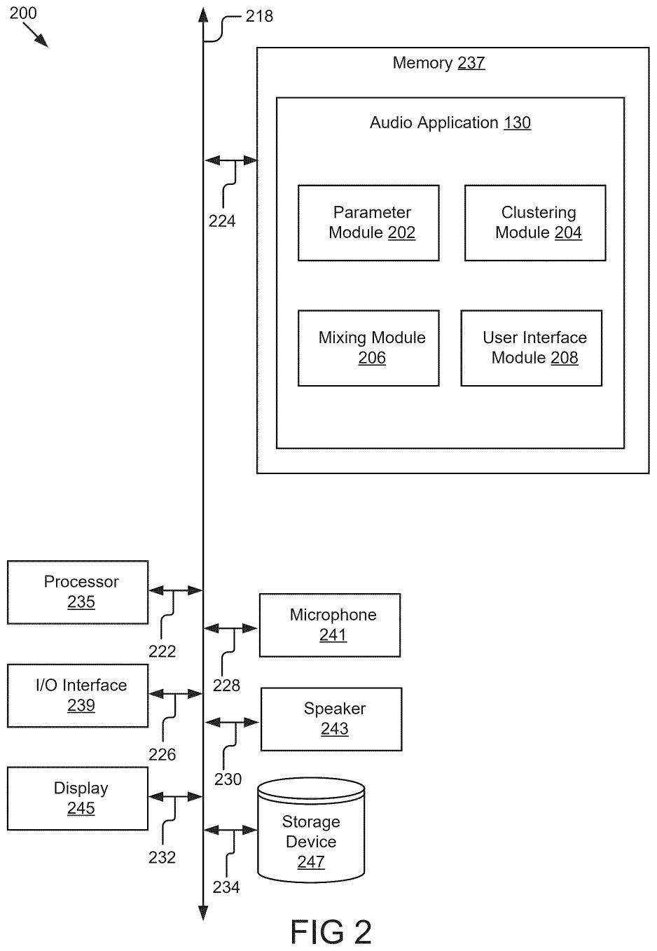

FIG. 2 is a block diagram of an example computing device 200 that may be used to implement one or more features described herein. Computing device 200 can be any suitable computer system, server, or other electronic or hardware device. In some embodiments, the computing device 200 is the online virtual experiences server 102 illustrated in FIG. 1. In some embodiments, the computing device is the client device 110. In some embodiments, one or more steps are performed on the online virtual experiences server 102 and one or more steps are performed on the client device 110.

In some embodiments, computing device 200 includes a processor 235, a memory 237, an Input/Output (I/O) interface 239, a microphone 241, one or more speakers 243, a display 245, and a storage device 247, all coupled via a bus 218. In some embodiments, the computing device 200 includes additional components not illustrated in FIG. 2.

The processor 235 may be coupled to a bus 218 via signal line 222, the memory 237 may be coupled to the bus 218 via signal line 224, the I/O interface 239 may be coupled to the bus 218 via signal line 226, the microphone 241 may be coupled to the bus 218 via signal line 228, the speaker 243 may be coupled to the bus 218 via signal line 230, the display 245 may be coupled to the bus 218 via signal line 232, and the storage device 247 may be coupled to the bus 218 via signal line 234.

The processor 235 includes an arithmetic logic unit, a microprocessor, a general-purpose controller, or some other processor array to perform computations and provide instructions to a display device. Processor 235 processes data and may include various computing architectures including a complex instruction set computer (CISC) architecture, a reduced instruction set computer (RISC) architecture, or an architecture implementing a combination of instruction sets. In some implementations, the processor 235 may include special-purpose units, e.g., machine learning processor, audio/video encoding and decoding processor, etc. Although FIG. 2 illustrates a single processor 235, multiple processors 235 may be included. In different embodiments, processor 235 may be a single-core processor or a multicore processor. Other processors (e.g., graphics processing units), operating systems, sensors, displays, and/or physical configurations may be part of the computing device 200, such as a keyboard, mouse, etc.

The memory 237 stores instructions that may be executed by the processor 235 and/or data. The instructions may include code and/or routines for performing the techniques described herein. The memory 237 may be a dynamic random access memory (DRAM) device, a static RAM, or some other memory device. In some embodiments, the memory 237 also includes a non-volatile memory, such as a static random access memory (SRAM) device or flash memory, or similar permanent storage device and media including a hard disk drive, a compact disc read only memory (CD-ROM) device, a DVD-ROM device, a DVD-RAM device, a DVD-RW device, a flash memory device, or some other mass storage device for storing information on a more permanent basis. The memory 237 includes code and routines operable to execute the audio application 130, which is described in greater detail below.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 247), and input/output devices can communicate via I/O interface 239. In another example, the I/O interface 239 can receive data from the server 101 and deliver the data to the audio application 130 and components of the audio application 130. In some embodiments, the I/O interface 239 can connect to interface devices such as input devices (keyboard, pointing device, touchscreen, microphone 241, sensors, etc.) and/or output devices (display 245, speaker 243, etc.).

Some examples of interfaced devices that can connect to I/O interface 239 can include a display 245 that can be used to display content, e.g., images, video, and/or a user interface of the metaverse as described herein, and to receive touch (or gesture) input from a user. Display 245 can include any suitable display device such as a liquid crystal display (LCD), light emitting diode (LED), or plasma display screen, cathode ray tube (CRT), television, monitor, touchscreen, three-dimensional display screen, a projector (e.g., a 3D projector), or other visual display device.

The microphone 241 includes hardware, e.g., one or more microphones that detect audio spoken by a person. The microphone 241 may transmit the audio to the audio application 130 via the I/O interface 239.

The speaker 243 includes hardware for generating audio for playback. For example, the speaker 243 receives the mixed audio for output during interaction with the virtual experience from the audio application 130. In some embodiments, the speaker 243 may include multiple audio output devices (e.g., stereo speaker with 2 output devices, surround speaker with 3, 4, 5, or more output devices) that produce sound.

In some embodiments, the speaker 243 may reproduce spatial audio by outputting a respective sound from each audio output device to together produce a spatial effect. For example, spatial audio may provide an effect where specific sounds originate from specific positions in a three-dimensional space (e.g., corresponding to avatar positions in the virtual environment). Further, spatial audio may also provide an effect where a listener head orientation may be taken into account while reproducing audio via the output devices to modify the playback such that it matches the current listener head orientation. With spatial audio, the audio experienced by a user 125 may be realistic and match their current position and orientation in the virtual experience.

The storage device 247 stores data related to the audio application 130. For example, the storage device 247 may store a user profile associated with a user 125, artificial audio, etc.

### Audio Application

FIG. 2 illustrates a computing device 200 that executes an example audio application 130 that includes a parameter module 202, a clustering module 204, a mixing module 206, and a user interface module 208. In some embodiments, a single computing device 200 includes all the components illustrated in FIG. 2. In some embodiments, one or more of the components are on different computing devices 200. For example, the online virtual experience server 102 may include the parameter module 202 and the clustering module 204, while the mixing module 202 and the user interface module 208 are part of the client device 110.

The parameter module 202 determines different parameters relating to audio sources. In some embodiments, the parameter module 202 excludes audio streams from consideration that are below an audible threshold (e.g., 20 decibels (dBs), 25 dBs, etc.). As a result, client devices do not receive audio streams below the audible threshold. In some embodiments, the parameter module 202 monitors audio streams to identify when they meet the audible threshold and when the audio streams fail to meet the audible threshold.

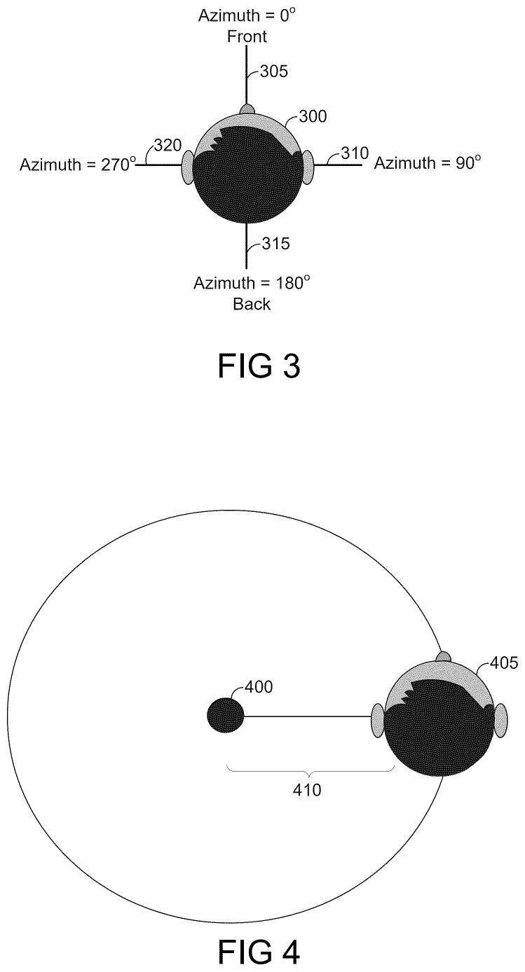

Turning to FIG. 3, an example of sound localization relative to a listener 300 is illustrated, according to some embodiments described herein. The position of an audio source may be described in a 3D environment as being a function of an azimuth, an elevation, and a distance for static sounds or a velocity for moving sounds. The azimuth is on a horizontal plane and is defined as an angle between the audio source and a listener on a median plane. The azimuth starts from a cardinal direction, usually north. In this example, the azimuth is 0 degrees 305 at the front of the listener 300, the azimuth is 90 degrees 310 at the listener's 300 right ear, the azimuth is 180 degrees 315 at the back of the listener 300, and the azimuth is 270 degrees 320 at the listener's 300 left ear. Elevation is on a vertical plane and is defined as an angle between the listener 300 and the audio source on the horizontal plane.

FIG. 4 is an example illustration of how sound attenuation works as a function of distance, according to some embodiments described herein. FIG. 4 illustrates an audio source 400 and a listener 405 with a distance 410 (i.e., radius) between the audio source 400 and the listener 405.

Sound attenuation in a real environment works according to the inverse square law, which measures the reduction in intensity of an audio source as a function of distance:

$$I = \frac{W}{4 π {r}^{2}} \qquad Eq . 1$$

where I is the intensity at a wavefront of the audio source, W is the power of the audio source, and r is the radius (i.e., the distance between a sound source in a virtual experience and a listener, such as an avatar in a virtual experience). For example, an omnidirectional audio source with no objects impeding the sound will decay by 6 dB for every doubling of the distance. If the audio source is directional, the audio source decays by 3 dB for every doubling of the distance. In some embodiments, the parameter module 202 uses the inverse square law to simulate sound attenuation in the virtual experience. In some embodiments, the parameter module 202 customizes the inverse square law for the virtual experience, such as by changing the distance that results in audio decay.

In some embodiments, the parameter module 202 uses the real-world laws of physics to determine sound propagation in a virtual experience. For example, the parameter module 202 may use a spherical spreading for sound, such as the one illustrated in FIG. 4. Other attenuation shapes can be used, such as a square or cube. For example, such attenuation shapes may be applicable for virtual experiences that include avatars that spend time in virtual rooms.

In some embodiments, the parameter module 202 determines an audibility of an audio source based on a dB level of the audio source, a distance between a position of the first avatar and a position of the audio source in the virtual experience, and/or other factors. In some embodiments, the parameter module 202 determines that a first audio source is louder than a second audio source, even when the first audio source is further away from a reference point, because the first audio source is louder than the second audio source (e.g., because the first audio source is a first avatar that is shouting and the second audio source is a second avatar that is speaking at a conversational volume).

The other factors may include objects that change how sound is modified or occluding objects. For example, an avatar with a bullhorn has amplified sound. In another example, if an object is between an audio source and an avatar associated with a user, the object may prevent the audio source from reaching the user. The parameter module 202 may determine the audibility based on the type of object (e.g., a truck blocks sound to a greater degree than a bush). In some embodiments, the parameter module 202 performs ray tracing (e.g., from the audio source to the avatar or vice-versa) to determine if audio from the audio source may reflect off of other objects (e.g., walls) and may be audible to an avatar.

The parameter module 202 determines a position of a first avatar associated with a user in a virtual experience and positions of other avatars in the virtual experience. The parameter module 202 detects a predetermined number of audio sources in the virtual experience that are audible to a first avatar in the virtual experience. For example, the parameter module 202 may determine 4-7 audio sources (or 3, or 10, etc.) that are the loudest where loudness is a function of distance and/or amplitudes of sound waves associated with the audio sources. The parameter module 202 detects a remaining audio sources that are audible in the virtual experience that are audible to the first avatar in the virtual experience. In some embodiments, the parameter module 202 replaces the remaining audio sources that are audible with artificial audio.

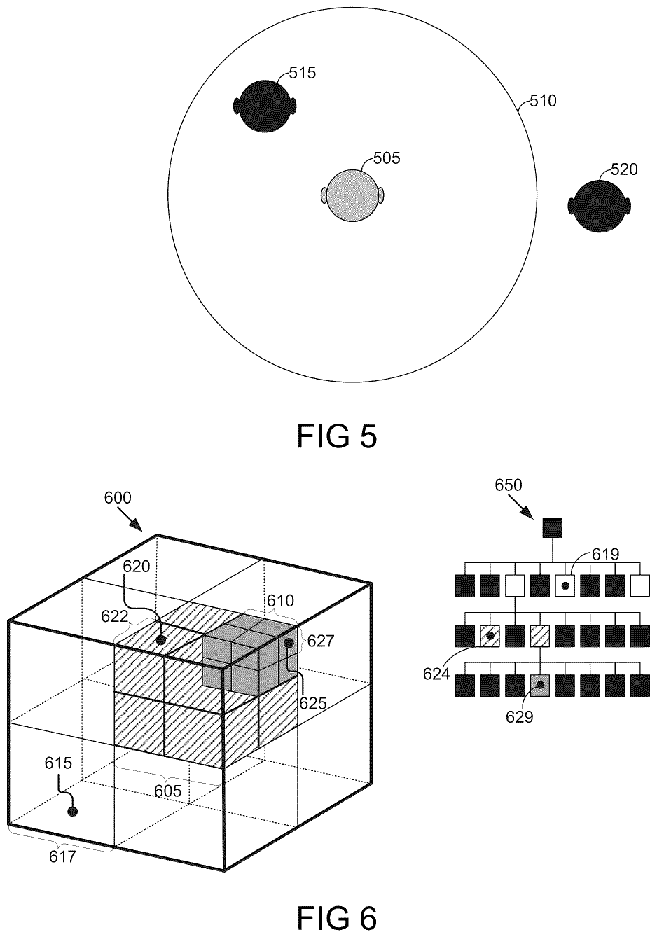

FIG. 5 is an example illustration of using a threshold distance 510 from a first avatar 505 to audio sources 515, 520 to determine whether to replace the audio sources 515, 520 with artificial audio, according to some embodiments described herein. In this example, the threshold distance 510 forms a circle (or in some embodiments, a sphere) around the first avatar 505. The first audio source 515 is within the threshold distance 510 and the second audio source 520 is more than the threshold distance 510.

The parameter module 202 replaces the second audio source 520 with artificial audio. In some embodiments, determining whether to replace the audio sources 515, 520 with artificial audio is based on audibility, where audibility is a function of distance and amplitudes of sound waves. For example, if a number of audio sources that are audible meets a predetermined threshold, the parameter module 202 identifies a predetermined number of audio sources that are the most audible (i.e., the loudest) and replaces remaining audio sources that are audible with artificial audio.

The mixing module 206 mixes additional audio from the first audio source 515 with artificial audio that represents the second audio source 520. The mixing module 206 provides the mixed audio to one or more speakers for output on a client device.

In some embodiments, the parameter module 202 identifies one or more respective parameters associated with the audio sources. For example, the parameters may include an orientation associated with each of the audio sources. The parameter module 202 may replace one or more of the remaining audio sources beyond a predetermined number of audio sources with artificial audio based on the one or more respective parameters. The parameter module 202 may replace the audio sources that are at least a threshold distance from the position of the first avatar with artificial audio based on the one or more respective parameters. For example, if the parameters include an orientation component, the artificial audio includes an orientation component. Continuing with the example in FIG. 4, the audio source 400 has an azimuth of 270 degrees as compared to the position of the listener 405. As a result, the orientation component includes a higher volume level of audio for the listener's 405 left ear than the listener's 405 right ear.

In some embodiments, the parameter module 202 determines a density of audio sources, such as a threshold density of a predetermined number of audio sources in a particular area of the virtual experience and replaces audio sources with artificial audio based on the threshold density. For example, a dense area may include artificial audio that sounds as if many avatars (with associated users speaking or providing other audio) are speaking unintelligibly. In some embodiments, the parameter module 202 determines a number of avatars that are speaking and the mixing module 206 replaces audio sources with artificial audio based on the number of audio sources.

In some embodiments, the parameter module 202 determines a decibel level of audio sources and the mixing module 206 replaces audio sources with artificial audio based on corresponding decibel levels. For example, if audio sources are loud (e.g., meet a loudness threshold) and are equivalent to yelling, the artificial audio may be played at a decibel level that indicates that avatars are yelling. In some embodiments, the parameter module 202 replaces the audio sources with artificial audio based on multiple parameters that include a density of audio sources, a number of avatars that are speaking, a decibel level of audio sources, and/or an orientation of an avatar. For example, the parameter module 202 may include both an orientation and a particular decibel level that the mixing module 206 uses for the artificial audio. In some embodiments, the mixing module 206 modifies an artificial audio file for one or more audio source based on the one or more respective parameters instead of creating individual artificial audio streams for each audio source.

### Clustering

In some embodiments, the clustering module 204 generates clusters of audio sources based on respective positions of audio sources. In some embodiments, the clusters of audio sources are generated for audio sources that are beyond the threshold distance from the position of a first avatar in the virtual experience. The clustering module 204 replaces the audio sources in individual clusters of the clusters with respective artificial audio. The respective artificial audio may be modified for individual clusters based on one or more respective parameters.

In some embodiments, the clustering module 204 generates artificial audio for individual clusters that include an orientation component. For example, the orientation may be averaged from the orientation of different audio sources within a cluster, the decibel level may be based on a distance of the audio sources within a cluster and the first avatar in the virtual experience, etc.

In some embodiments, the clustering module 204 partitions the virtual experience into an octree. An octree is a tree data structure in which each internal node has eight children. The clustering module 204 generates the octree by recursively subdividing the virtual experience into one or more progressively smaller sets of octants (i.e., eight parts). The clustering module 204 associates each octant within the octree with a corresponding cluster. In some embodiments, the clustering module 204 includes a machine-learning model that is trained to generate the octree. For example, the machine-learning model receives as input information associated with the virtual experience (e.g., dimensions, objects, avatars, etc.) and outputs the octree.

FIG. 6 is an example illustration of a virtual experience 600 that illustrates three sets of octants in an octree, according to some embodiments described herein. The octree includes additional subtrees that are not illustrated for the sake of clarity in the illustration. The virtual experience 600 is saved as a tree structure 650 that maps the location of the different octants in the three sets of illustrated octrees. For example, the virtual experience 600 includes eight largest octants that are represented by seven white cubes (such as cube 617) and one lined cube 605. The lined cube 605 includes a set of octants that illustrates how one octant (i.e., cube 605) is further divided into eight smaller octants. Each octant within the lined cube 605 can be further divided into eight octants. For example, cube 610 is illustrated as a set of eight octants, such as cube 627.

When objects are located within an octant, the objects are registered as being associated with an octant in the tree structure 650. For example, object 615, which is in one of the largest octants 617, is registered as being at position 619 in the tree structure 650. In another example, object 620, which is in one of the second largest octants 622, is registered as being at position 624 in the tree structure 650. In yet another example, object 625, which is in one of the smallest octants 627, is registered as being at position 629 in the tree structure.

In some embodiments, the clustering module 204 partitions the sets of eight octants based on a position of the first avatar so that a size of the eight octants in a set increases as a distance between the first avatar and a set of eight octants increases. For example, in FIG. 6, if object 625 is a first avatar that is part of one of the smallest octants 627, remaining audio sources that are audible that are within the octant 627 are nearby and a small number of remaining audio sources that are audible would be included within the gray cube 610. Object 620 is farther away and is part of a larger octree 622, which can include a much larger number of audio sources because the octree 622 is larger. Object 615 is farthest away and is part of one of the largest octrees 617 and can include the largest number of audio sources within the octree 617. In some embodiments, the clustering module 204 combines two or more clusters. For example, the clustering module 204 may combine two or more clusters if the density in the clusters is below a density threshold value.

In some embodiments, the clustering module 204 dynamically partitions a virtual experience as a first avatar moves within the virtual experience. For example, the clustering module 204 may repartition a virtual experience responsive to the first avatar moving a predetermined distance. In another example, the clustering module 204 may dynamically adjust the clusters based on a density of avatars in the virtual experience.

In some embodiments, the clustering module 204 identifies amplitudes and frequencies of the sound waves associated with audio sources in corresponding octants. The amplitude of a sound wave is a measurement of the displacement: the bigger the amplitude, the louder the sound. The frequency of a sound wave is a measurement of how many peaks of the wave go by per second: the higher the frequency, the higher the tone sounds. The clustering module 204 may determine a corresponding distance between the audio sources in the corresponding clusters and the first avatar.

The mixing module 206 may generate respective artificial audio for individual clusters by modifying the artificial audio based on the amplitude, the frequency, and the corresponding distance. For example, if a cluster has a high amplitude that indicates that people are shouting, but the cluster is a far distance from the first user, the mixing module 206 modifies the amplitude of the sound waves in an artificial audio file or an artificial audio stream based on the distance. In another example, if the audio sources in a cluster have a high frequency, the mixing module 206 modifies the frequency of the sound waves in the artificial audio file based on the frequency of the audio sources in the cluster. In some embodiments, the clustering module 204 provides an average frequency and/or an average amplitude for a cluster to the mixing module 206 for modification of the artificial audio file. In some embodiments, the clustering module 204 uses a combination of amplitude and frequency to determine how much audio the avatars are emitting and applies a filter to the artificial audio file to create a similar general ambience. As a result, if the avatars in the virtual experience do not often speak, this may reduce how much artificial audio is emitted.

In some embodiments, the clustering module 204 samples one or more audio streams in one or more of the clusters that the mixing module 206 combines with the artificial audio. For example, the clustering module 204 samples live audio streams in a cluster and averages the sampled streams of live audio. In some embodiments, the clustering module 204 samples a predetermined percentage of audio streams, such as 20% of the audio streams. The clustering module 204 may transmit the sampled live audio streams to a mixing module 206 stored on a client device. In some embodiments, the clustering module 204 compresses (i.e., encodes) the sampled live audio streams to reduce the bandwidth constraints associated with transmitting the sampled live audio to the client device. The mixing module 206, for individual clusters, combines the artificial audio with the averaged stream.

Using an average of the live audio streams advantageously results in a pattern of sounds responding to certain events that is consistent without the risk of providing a distinct audio stream that may include inappropriate words or audio from users that are blocked. For example, if the audio streams are averaged from avatars associated with users that are watching a sports match, the audio may be an average of people saying positive statements, such as “Go!” and “Run faster” at the same time while masking inappropriate statements such as expletives. The advantage of combining live audio streams with artificial audio for the clusters is that an event sounds more realistic. For example, if a performer sings a well-known song and points at different sections of the audience to sing with him, including samples of people in the audience singing results in dynamic movement of the audio (e.g., similar to that experienced at a real-world concert at a large venue). In another example, using live audio streams from different regions within a crowd may simulate the progression of chanting or cheering in a particular pattern. In some embodiments where the number of live audio sources fails to meet a threshold number of audio sources, the live audio streams may be combined with samples of artificial audio to prevent any of the live audio streams and possible inappropriate words from being discernable.

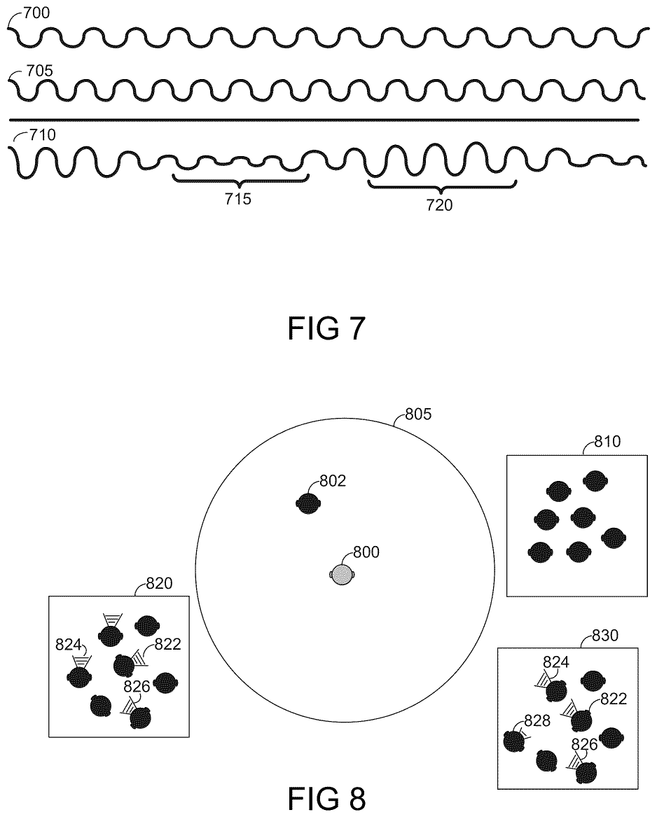

FIG. 7 is an example illustration of two audio source samples that are averaged, according to some embodiments described herein. The first audio stream 700 and the second audio stream 705 have several sections that are similar, but other sections where they are different. As a result, the averaged audio stream 710 includes a section where the average results are destructive 715 and are unintelligible and another section where the average results are constructive 720 and the sound waves sound more similar to the first audio stream 700 and the second audio stream 705.

In some embodiments, the clustering module 204 samples the streams of live audio based on one or more respective parameters. The one or more respective parameters may include an orientation associated with each of the plurality of audio sources, a density of the plurality of audio sources, a number of other avatars that are speaking, and/or a decibel level of the plurality of audio sources. In some embodiments, the clustering module 204 averages the streams of live audio based on the one or more respective parameters. In some embodiments, the clustering module 204 includes a machine-learning model that is trained to receive the streams of live audio and the one or more respective parameters as input and outputs averaged live audio.

FIG. 8 is an example illustration of different ways to sample clusters to replace the audio sources with artificial audio, according to some embodiments described herein. A distance threshold 805 is established based on the position of the first avatar 800. Audio sources, such as audio source 802, that are within a distance threshold 805 from the position of the first avatar 800 are provided as part of a mix of audio streams to a client device of a user associated with the first avatar 800.

The clustering module 204 generates a first cluster 810, a second cluster 820, and a third cluster 830. In this example, none of the audio sources in the first cluster 810 are speaking. In some embodiments, the first cluster 810 samples any audio sources in the first cluster 810 once any audio sources are speaking.

The clustering module 204 samples audio sources in the second cluster 820 based on a number of audio sources that are speaking. Specifically, audio sources 822, 824, and 826 are speaking. In some embodiments, the clustering module 204 dynamically modifies the sampling of audio sources to sample different audio sources if additional audio sources start speaking, stop sampling one of the audio sources 822, 824, and 826 if they stop speaking, etc. In some embodiments, the clustering module 204 samples a subset of the audio sources if a predetermined number or a predetermined percentage of audio sources are speaking. For example, the clustering module 204 may sample 50% of the audio sources that are speaking up to four audio sources (or other percentages and numbers).

The clustering module 204 samples audio sources in the third cluster 830 based on an orientation of the audio sources. For example, the clustering module 204 samples audio sources 822, 824, 826 because the audio sources are facing the first avatar 800. The clustering module 204 does not sample audio source 828 because they are not facing the first avatar 800.

### Mixing

The mixing module 206 mixes audio streams with artificial audio for a client device 110. In some embodiments, a mixing module 206 stored on the client device 110 receives, from a mixing module 206 stored on the online virtual experience server 102, audio streams that are associated with the predetermined number of audio sources in the virtual experience. The mixing module 206 on the online virtual experiences server 102 may generate encoded audio streams that has a reduced bandwidth for easier transmission.

The mixing module 206 generates artificial audio for remaining audio sources that are audible. The artificial audio includes an unintelligible mix of sound and/or random pseudo-speech, such as Walla, which is a sound effect imitating the murmur of a crowd in the background. In some embodiments, the artificial audio may include pre-recorded speech sounds, pre-recorded speech-like sounds (e.g., people repeating the word “walla” or another word that sounds like the murmuring of a crowd), speech sounds synthesized in real-time, and/or speech-like sounds synthesized in real-time. In some embodiments, the artificial audio is an artificial audio file or stream that is modified for each audio source and/or cluster of audio sources during the mixing.

In some embodiments, the mixing module 206 receives information about one or more respective parameters related to the remaining audio sources that are audible that are not part of the predetermined number of audio sources that are audible. For example, the mixing module 206 may receive position information for the audio sources, orientation of the audio sources, a decibel level of the audio sources, an average frequency of audio sources in individual clusters, etc. The mixing module 206 may mix the audio streams with the artificial audio.

In some embodiments, the mixing module 206 generates artificial audio based on information about the one or more respective parameters. For example, the mixing module 206 generates artificial audio with a decibel level that attenuates as a function of the position and the orientation of an audio source based on a distance between the first avatar and other audio sources. In some embodiments, the mixing module 206 generates the artificial audio by modifying the artificial audio file or stream based on the information about the one or more respective parameters.

The mixing module 206 may use the orientation of the audio sources to determine a directionality of the audio sources and consider how the directionality affects panning. Panning is a technique used to spread a mono- or a stereo-sound signal into a new stereo- or multi-channel sound signal. Panning can simulate the spatial perspective of the listener by varying the amplitude or power level of the original source across the new audio channels. For example, audio coming from the 0 degree azimuth 305 as illustrated in FIG. 3 may be equally distributed across a left speaker 243 and a right speaker 243, whereas audio coming from the 270 degree position 320 is received by only the left speaker 243, and audio coming from the 90 degree position 310 is received by only the right speaker 243. The mixing module 206 ensures that the additional audio is panned the same way as the first audio stream to so that both audio streams are heard with equal proportions in the left speaker 243 and the right speaker 243. If panning is not taken into consideration, in some embodiments, a situation may arise where the user's left speaker 243 the user's right speaker 243 receive different mixed audio that is jarring and that can cause sensory issues, such as nausea.

In some embodiments, the mixing module 206 mixes the artificial audio with one or more averaged streams of live audio from one or more different clusters. For example, the mixing module 206 may combine the artificial audio from individual clusters with an averaged stream of live audio from individual clusters to form mixed artificial audio.

The mixing module 206 mixes the artificial audio (and/or the mixed artificial audio) with the audio streams (e.g., encoded audio). The audio streams are generated from the predetermined number of audio sources with spatial characteristics. The mixing module 206 provides the mixed audio to one or more speakers 243 for output at the client device. In some embodiments, the artificial audio, the averaged streams of live audio, and the audio streams are mixed at the same time or the artificial audio and the averaged streams of live audio are mixed first (e.g., at a server) and the mixed artificial audio and averaged streams of live audio are mixed with the audio streams (e.g., at a client device).

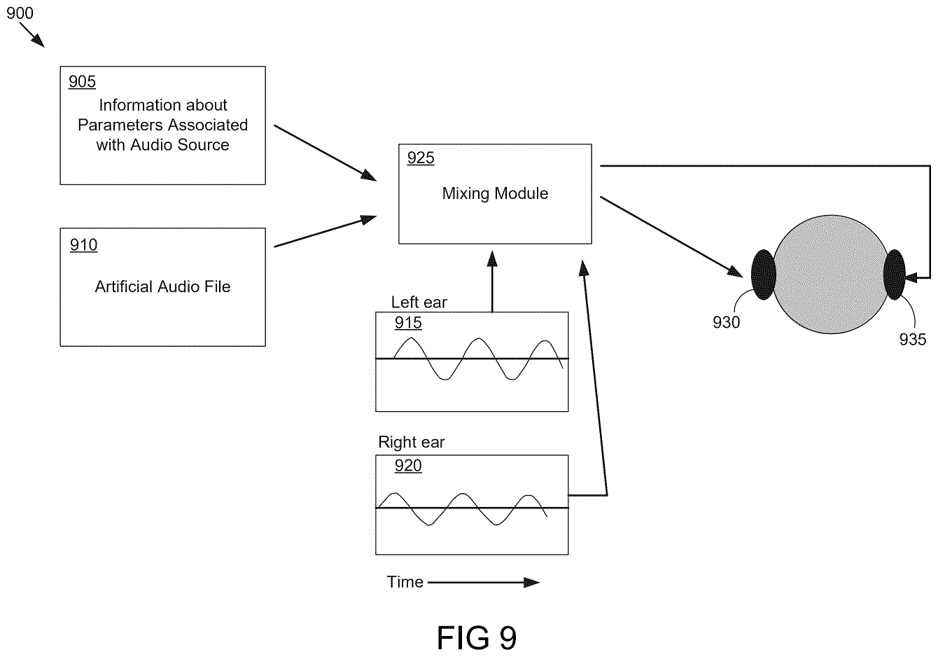

FIG. 9 is a block diagram 900 of an example process for mixing artificial audio with audio streams that is output to a left speaker 930 and a right speaker 935, according to some embodiments described herein. FIG. 9 illustrates an example where a single audio source that is at least a threshold distance from a first avatar is identified. Information 905 about parameters associated with the audio source are provided to a mixing module 925. The mixing module 925 also receives an artificial audio file. The mixing module 925 modifies the artificial audio file 910 based on the information 905 about parameters associated with the audio source. For example, the mixing module 925 attenuates the artificial audio based on a distance between the first avatar and the audio source.

The mixing module 925 also receives a left-ear sound wave 915 and a right-ear sound wave 920 that are associated with one or more audio streams that are associated with the predetermined number of audio sources in the virtual experience. The mixing module 925 mixes the modified artificial audio with the left-ear sound wave 915 and the right-ear sound wave 920 to generate mixed audio that includes a left channel that is output to a left speaker 930 and a right channel that is output to a right speaker 935. The mixed audio that is sent to each speaker may be different based on modifications made due to the orientation of the first avatar and how the sound is perceived as travelling in the virtual experience.

The user interface module 208 generates a user interface for users associated with client devices to specify user preferences. The user interface may include options for specifying different parameters, such as a threshold distance from a position of a first avatar associated with a user to a position of another avatar after which audio associated with the other avatar is replaced with artificial audio. In some embodiments, the parameters may include a preference for how to prioritize different factors. For example, a user may prefer to prioritize the visual appearance of a virtual experience over audio quality.

In some embodiments, the user preferences include an option for a user to specify a number of audio streams that are provided to the user. For example, a user may prefer to hear no more than four distinct audio streams. As a result of specifying this preference, the parameter module 202 may replace audio sources for other avatars that are less audible with artificial audio. In some embodiments, the user preferences include the amplitude (i.e., sound volume) of the artificial audio. For example, a user may specify that they want only three distinct audio streams to be audible and the artificial audio for the other avatars is at a low sound level so that it does not distract the user. In some embodiments, the artificial audio may be event specific. For example, the user may prefer louder artificial audio if they are attending a virtual concert or a virtual sports game than if they are in a virtual experience where they are hiking with a small group of other avatars.

### Methods

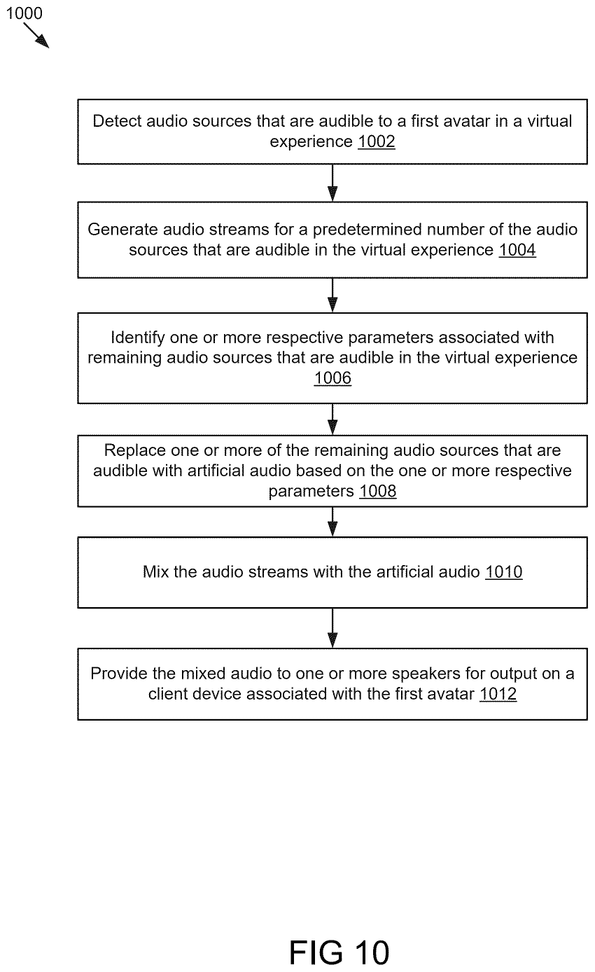

FIG. 10 is a flow diagram of an example method 1000 to replace a plurality of audio sources with artificial audio based on one or more respective parameters that are mixed on a client device, according to some embodiments described herein. In some embodiments, all or portions of the method 1000 are performed by the audio application 130 stored on the online virtual experiences server 102, a virtual experience application 112 stored on the client device 110, or in part on the virtual experiences server 102 and in part on the client device 110 as illustrated in FIG. 1. In some embodiments, all or portions of the method 1000 are performed by the audio application 130 stored on the computing device 200 of FIG. 2.

The method 1000 may begin with block 1002. At block 1002, audio sources are detected that are audible to a first avatar in a virtual experience. Block 1002 may be followed by block 1004.

At block 1004, audio streams are generated for a predetermined number of the audio sources that are audible in the virtual experience. The predetermined number of the audio sources that are audible may be the more audible audio sources in the virtual environment (i.e., the loudest). The method 1000 may further include determining a position of the first avatar in the virtual experience and determining the predetermined number of audio sources in the virtual experience that are audible to the first avatar based on one or more of a distance between first avatar and respective positions of the predetermined audio sources, respective amplitudes of sound waves associated with the predetermined audio sources, and combinations thereof. Block 1004 may be followed by block 1006.

At block 1006, one or more respective parameters associated with remaining audio sources that are audible in the virtual experience are identified. The method 1000 may further include transmitting information about the one or more respective parameters associated with the remaining audio sources that are audible and the audio streams to the client device. Block 1006 may be followed by block 1008.

At block 1008, one or more of the remaining audio sources that are audible are replaced with artificial audio based on the one or more respective parameters. Block 1008 may be followed by block 1010.

At block 1010, the artificial audio is mixed with the additional audio. The artificial audio may be mixed locally at the client device. Block 1010 may be followed by block 1012.

At block 1012, the mixed audio is provided to one or more speakers for output on a client device associated with the first avatar.

In some embodiments, the method 1000 further includes determining a position of the first avatar in the virtual experience and generating a plurality of clusters of the remaining audio sources that are audible based on respective positions of the remaining audio sources that are audible, wherein replacing the remaining audio sources that are audible with the artificial audio based on the one or more respective parameters includes replacing the remaining audio sources that are audible with respective artificial audio for individual clusters of the plurality of clusters. Generating the plurality of clusters of the remaining audio sources that are audible may include partitioning the virtual experience into an octree by recursively subdividing the virtual experience into one or more progressively smaller sets of octants and associating each octant within the octree with a corresponding cluster from the plurality of clusters. The respective artificial audio for individual clusters of the plurality of clusters may be generated by, for the cluster, identifying amplitudes and frequencies of the remaining audio sources that are audible in the cluster and generating the artificial audio for the cluster by modifying the remaining audio sources that are audible based on the amplitudes and the frequencies.

In some embodiments, the method 1000 may further include sampling streams of live audio in individual clusters of the plurality of clusters and averaging the sampled streams of live audio, where mixing the audio streams with the artificial audio includes mixing, for individual clusters, the averaged streams of live audio, the artificial audio, and the audio streams. The one or more respective parameters may be selected from a group of an orientation associated with each of the remaining audio sources that are audible in individual clusters of the plurality of clusters, a density of the remaining audio sources that are audible in individual clusters of the plurality of clusters, a number of other avatars that are speaking in individual clusters of the plurality of clusters, a decibel level of the remaining audio sources that are audible in individual clusters of the plurality of clusters, an average frequency of the remaining audio sources that are audible in individual clusters of the plurality of clusters, and combinations thereof and the streams of live audio may be sampled based on the one or more respective parameters.

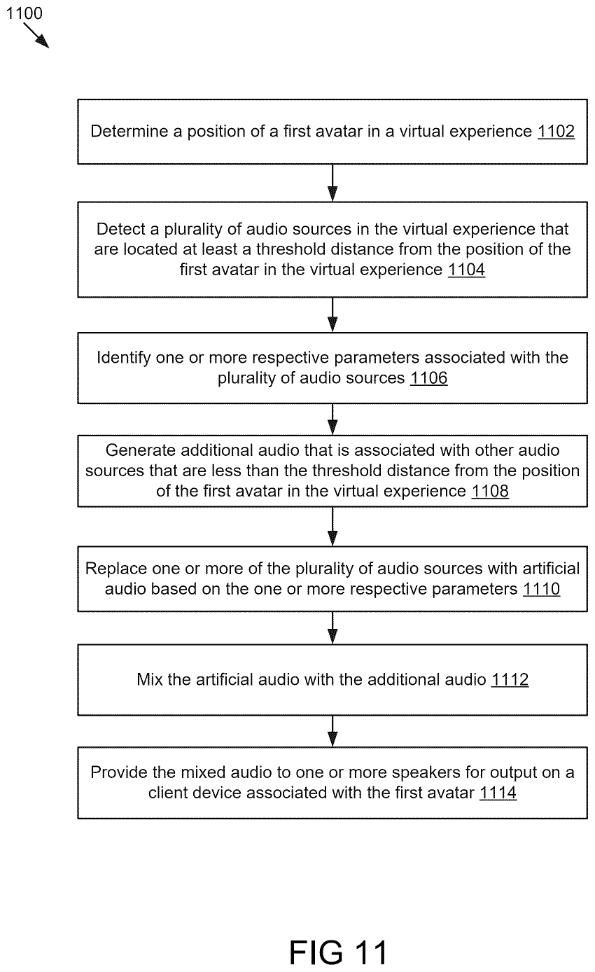

FIG. 11 is a flow diagram of another example method 1100 to replace a plurality of audio sources with artificial audio based on one or more respective parameters, according to some embodiments described herein. In some embodiments, all or portions of the method 1100 are performed by the audio application 130 stored on the online virtual experiences server 102, a virtual experience application 112 stored on the client device 110, or in part on the virtual experiences server 102 and in part on the client device 110 as illustrated in FIG. 1. In some embodiments, all or portions of the method 1000 are performed by the audio application 130 stored on the computing device 200 of FIG. 2.

The method 1100 may begin with block 1102. At block 1102, A position of a first avatar in a virtual experience is determined. Block 1102 may be followed by block 1104.

At block 1104, a plurality of audio sources are detected in the virtual experience that are located at least a threshold distance from the position of the first avatar in the virtual experience. Block 1104 may be followed by block 1106.

At block 1106, one or more respective parameters associated with the plurality of audio sources are identified. The one or more respective parameters may include an orientation associated with each of the plurality of audio sources, a density of the plurality of audio sources, a number of other avatars that are speaking, and/or a decibel level of the plurality of audio sources. Block 1006 may be followed by block 1108.

At block 1108, additional audio that is associated with other audio sources that are less than the threshold distance from the position of the first avatar in the virtual experience is generated. Block 1108 may be followed by block 1110.

At block 1110, one or more of the plurality of audio sources are replaced with artificial audio based on the one or more respective parameters. The artificial audio may include the artificial audio is selected from a group of pre-recorded audio sounds, pre-recorded audio-like sounds, audio sounds synthesized in real-time, and/or audio-like sounds synthesized in real-time.

In some embodiments, a plurality of clusters of audio sources are generated based on respective positions of the plurality of audio sources and replacing the plurality of audio sources with respective artificial audio for individual clusters of the plurality of clusters. The plurality of clusters of audio sources may be generated by partitioning the virtual experience into an octree by recursively subdividing the virtual experience into one or more progressively smaller sets of octants and associating each octant within the octree with a corresponding cluster from the plurality of clusters. In some embodiments, the respective artificial audio for individual clusters of the plurality of clusters is generated by, for the cluster: identifying amplitudes and frequencies of the plurality of audio sources in the cluster, determining a distance between the plurality of audio sources in the cluster and the position of the first avatar, and generating the artificial audio for the cluster by modifying the plurality of audio sources based on the amplitudes, the frequencies, and the distance. In some embodiments, the method 1100 further includes sampling streams of live audio in individual clusters of the plurality of clusters and averaging the sampled streams of live audio, where mixing the additional audio with the artificial audio includes mixing, for individual clusters, the sampled streams of live audio, the artificial audio, and the additional audio. In some embodiments, the one or more respective parameters are selected from a group of the one or more respective parameters are selected from a group of an orientation associated with each of the plurality of audio sources in individual clusters of the plurality of clusters, a density of the plurality of audio sources in individual clusters of the plurality of clusters, a number of other avatars that are speaking in individual clusters of the plurality of clusters, a decibel level of the plurality of audio sources in individual clusters of the plurality of clusters, an average frequency of audio sources in individual clusters of the plurality of clusters, and combinations thereof. Block 1110 may be followed by block 1112.

At block 1112, the artificial audio is mixed with the additional audio. The artificial audio may be mixed locally at the client device. Block 1112 may be followed by block 1114.

At block 11114, the mixed audio is provided to one or more speakers for output on a client device associated with the first avatar.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

Various embodiments described herein include obtaining data from various sensors in a physical environment, analyzing such data, generating recommendations, and providing user interfaces. Data collection is performed only with specific user permission and in compliance with applicable regulations. The data are stored in compliance with applicable regulations, including anonymizing or otherwise modifying data to protect user privacy. Users are provided clear information about data collection, storage, and use, and are provided options to select the types of data that may be collected, stored, and utilized. Further, users control the devices where the data may be stored (e.g., client device only; client+server device; etc.) and where the data analysis is performed (e.g., client device only; client+server device; etc.). Data are utilized for the specific purposes as described herein. No data is shared with third parties without express user permission.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMS, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method comprising:
detecting audio sources that are audible to a first avatar in a virtual experience;
generating audio streams for a predetermined number of the audio sources that are audible in the virtual experience;
identifying one or more respective parameters associated with remaining audio sources that are audible in the virtual experience;
replacing one or more of the remaining audio sources that are audible with artificial audio based on the one or more respective parameters;
mixing the audio streams with the artificial audio; and
providing the mixed audio to one or more speakers for output on a client device associated with the first avatar.

2. The method of claim 1, further comprising:
determining a position of the first avatar in the virtual experience; and
determining the predetermined number of audio sources that are audible in the virtual experience based on one or more of a distance between first avatar and respective positions of the predetermined audio sources, respective amplitudes of sound waves associated with the predetermined audio sources, and combinations thereof.

3. The method of claim 1, further comprising:
determining a position of the first avatar in the virtual experience; and
generating a plurality of clusters of the remaining audio sources that are audible based on respective positions of the remaining audio sources that are audible, wherein replacing the remaining audio sources that are audible with the artificial audio based on the one or more respective parameters includes replacing the remaining audio sources that are audible with respective artificial audio for individual clusters of the plurality of clusters.

4. The method of claim 3, wherein generating the plurality of clusters of the remaining audio sources that are audible includes:
partitioning the virtual experience into an octree by recursively subdividing the virtual experience into one or more progressively smaller sets of octants; and
associating each octant within the octree with a corresponding cluster from the plurality of clusters.

5. The computer-implemented method of claim 4, wherein the respective artificial audio for individual clusters of the plurality of clusters is generated by, for the cluster:
identifying amplitudes and frequencies of the remaining audio sources that are audible in the cluster; and
generating the artificial audio for the cluster by modifying the remaining audio sources that are audible based on the amplitudes and the frequencies.

6. The computer-implemented method of claim 3, further comprising:
sampling streams of live audio in individual clusters of the plurality of clusters; and
averaging the sampled streams of live audio;
wherein mixing the audio streams with the artificial audio includes mixing, for individual clusters, the averaged streams of live audio, the artificial audio, and the audio streams.

7. The computer-implemented method of claim 6, wherein:
the one or more respective parameters are selected from a group of an orientation associated with each of the remaining audio sources that are audible in individual clusters of the plurality of clusters, a density of the remaining audio sources that are audible in individual clusters of the plurality of clusters, a number of other avatars that are speaking in individual clusters of the plurality of clusters, a decibel level of the remaining audio sources that are audible in individual clusters of the plurality of clusters, an average frequency of the remaining audio sources that are audible in individual clusters of the plurality of clusters, and combinations thereof; and
the streams of live audio are sampled based on the one or more respective parameters.

8. The computer-implemented method of claim 1, further comprising:
transmitting information about the one or more respective parameters associated with the remaining audio sources that are audible and the audio streams to the client device;
wherein mixing the audio streams with the artificial audio is performed locally at the client device.

9. A system comprising:
one or more processors; and
a memory coupled to the one or more processors, with instructions stored thereon that, when executed by the one or more processors, cause the one or more processors to perform operations comprising:
detecting audio sources that are audible to a first avatar in a virtual experience;
generating audio streams for a predetermined number of the audio sources that are audible in the virtual experience;
identifying one or more respective parameters associated with remaining audio sources that are audible in the virtual experience;
replacing one or more of the remaining audio sources that are audible with artificial audio based on the one or more respective parameters;
mixing the audio streams with the artificial audio; and
providing the mixed audio to one or more speakers for output on a client device associated with the first avatar.

10. The system of claim 9, wherein the operations further include:
determining a position of the first avatar in the virtual experience; and
determining the predetermined number of audio sources that are audible in the virtual experience based on one or more of a distance between first avatar and respective positions of the predetermined audio sources, respective amplitudes of sound waves associated with the predetermined audio sources, and combinations thereof.

11. The system of claim 10, wherein the operations further include:
determining a position of the first avatar in the virtual experience; and
generating a plurality of clusters of the remaining audio sources that are audible based on respective positions of the remaining audio sources that are audible, wherein replacing the remaining audio sources that are audible with the artificial audio based on the one or more respective parameters includes replacing the remaining audio sources that are audible with respective artificial audio for individual clusters of the plurality of clusters.

12. The system of claim 11, wherein generating the plurality of clusters of the remaining audio sources that are audible includes:
partitioning the virtual experience into an octree by recursively subdividing the virtual experience into one or more progressively smaller sets of octants; and
associating each octant within the octree with a corresponding cluster from the plurality of clusters.

13. The system of claim 12, wherein the respective artificial audio for individual clusters of the plurality of clusters is generated by, for the cluster:
identifying amplitudes and frequencies of the remaining audio sources that are audible in the cluster; and
generating the artificial audio for the cluster by modifying the remaining audio sources that are audible based on the amplitudes and the frequencies.

14. The system of claim 11, wherein the operations further include:
sampling streams of live audio in individual clusters of the plurality of clusters; and
averaging the sampled streams of live audio;
wherein mixing the audio streams with the artificial audio includes mixing, for individual clusters, the averaged streams of live audio, the artificial audio, and the audio streams.

15. A non-transitory computer-readable medium with instructions stored thereon that, when executed by one or more computers, cause the one or more computers to perform operations, the operations comprising:
detecting audio sources that are audible to a first avatar in a virtual experience;
generating audio streams for a predetermined number of the audio sources that are audible in the virtual experience;
identifying one or more respective parameters associated with remaining audio sources that are audible in the virtual experience;
replacing one or more of the remaining audio sources that are audible with artificial audio based on the one or more respective parameters;
mixing the audio streams with the artificial audio; and
providing the mixed audio to one or more speakers for output on a client device associated with the first avatar.

16. The non-transitory computer-readable medium of claim 15, wherein the operations further include:
determining a position of the first avatar in the virtual experience; and
determining the predetermined number of audio sources that are audible in the virtual experience based on one or more of a distance between first avatar and respective positions of the predetermined audio sources, respective amplitudes of sound waves associated with the predetermined audio sources, and combinations thereof.

17. The non-transitory computer-readable medium of claim 15, wherein the operations further include:
determining a position of the first avatar in the virtual experience;
generating a plurality of clusters of the remaining audio sources that are audible based on respective positions of the remaining audio sources that are audible, wherein replacing the remaining audio sources that are audible with the artificial audio based on the one or more respective parameters includes replacing the remaining audio sources that are audible with respective artificial audio for individual clusters of the plurality of clusters.

18. The non-transitory computer-readable medium of claim 17, wherein generating the plurality of clusters of remaining audio sources that are audible includes:
partitioning the virtual experience into an octree by recursively subdividing the virtual experience into one or more progressively smaller sets of octants; and
associating each octant within the octree with a corresponding cluster from the plurality of clusters.

19. The non-transitory computer-readable medium of claim 18, wherein the respective artificial audio for individual clusters of the plurality of clusters is generated by, for the cluster:
identifying amplitudes and frequencies of the remaining audio sources that are audible in the cluster; and
generating the artificial audio for the cluster by modifying the remaining audio sources that are audible based on the amplitudes and the frequencies.

20. The non-transitory computer-readable medium of claim 17, wherein the operations further include:
sampling streams of live audio in individual clusters of the plurality of clusters; and
averaging the sampled streams of live audio;
wherein mixing the audio streams with the artificial audio includes mixing, for individual clusters, the averaged streams of live audio, the artificial audio, and the audio streams.
